(19) United States
(12) Patent Application Publication
(10) Pub. No.: US 2011/0123189 A1
(43) Pub. Date: May 26, 2011

(54) Camera

(76) Inventor: Tetsuo Saito, Ome-shi (JP)

(21) Appl. No.: 12/854,073

(22) Filed: Aug. 10, 2010

(30) Foreign Application Priority Data
Nov. 20, 2009 (JP) 2009-265353

(51) Int. Cl. G03B 17/02

(52) U.S. Cl. 396/535

(57) ABSTRACT

According to one embodiment, a camera includes a case provided with an opening portion and a front unit fixed to the case to cover the opening portion. The front unit includes a sensor holder having a sensor support unit which is housed in the case and to which an image sensor is fixed and a fitting portion protruding from the sensor support unit to the outside of the case, a front cover provided with a fitting hole in which the fitting portion is fitted and covering the opening portion, and a fixing unit which detachably fixes the front cover to the sensor holder.

### CROSS-REFERENCE TO RELATED APPLICATION

This application is based upon and claims the benefit of priority from Japanese Patent Application No. 2009-265353, filed Nov. 20, 2009; the entire contents of which are incorporated herein by reference.

### FIELD

Embodiments described herein relate generally to a camera comprising an image sensor.

### BACKGROUND

A camera, such as a digital video camera, which digitalizes and records an image, comprises an image sensor such as a CMOS image sensor or a CCD. In an image pickup apparatus disclosed in Jpn. Pat. Appln. KOKAI Publication No. 2001-166193, a CCD holder, to which a CCD is fixed, is housed in a cabinet of a personal computer camera.

A professional-use camera employs an integrally-formed component comprising a holder part and a front cover part. The holder part comprises a sensor support unit for fixing an image sensor. The front cover part covers an opening portion of a case of a camera. When a new type of camera is developed, the integrally-formed component comprising the holder part and front cover part is newly designed and manufactured.

The shape of a camera varies depending on the intended purpose. Thus, new types of cameras are developed in accordance with intended purposes. When a new type of camera is developed, a holder part is newly designed as well as a front cover part. Even when the sensor support part of the new type of camera, to which an image sensor is fixed, is the same as that of an old type of camera, the holder part is newly designed. Therefore, design-related costs and labor are increased. In addition, a new mold and raw material for molding the holder part are required. Accordingly, the costs for molds and manufacturing costs per unit are increased.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view showing a camera according to a first embodiment;

FIG. 2 is an exemplary perspective view showing a front unit according to the first embodiment;

FIG. 3 is an exemplary perspective view showing, from back, the front unit according to the first embodiment;

FIG. 4 is an exemplary exploded perspective view showing the front unit according to the first embodiment;

FIG. 5 is an exemplary longitudinal sectional view of the front unit according to the first embodiment;

FIG. 6 is an exemplary exploded perspective view of a sensor unit according to the first embodiment;

FIG. 7 is an exemplary longitudinal sectional view showing an internal configuration of the camera according to the first embodiment;

FIG. 8 is an exemplary horizontal sectional view showing an internal configuration of the camera according to the first embodiment;

FIG. 9 is an exemplary perspective view showing another form of the front unit according to the first embodiment;

FIG. 10 is an exemplary perspective view showing still more another form of the front unit according to the first embodiment;

FIG. 11 is an exemplary perspective view showing a front unit according to a second embodiment;

FIG. 12 is an exemplary perspective view showing a front unit according to a third embodiment;

FIG. 13 is an exemplary sectional view showing an internal configuration of a camera according to the third embodiment;

FIG. 14 is an exemplary exploded perspective view showing a front unit according to a fourth embodiment;

FIG. 15 is an exemplary exploded perspective view showing a front unit according to a fifth embodiment; and

FIG. 16 is an exemplary exploded perspective view showing a front unit according to a sixth embodiment.

### DETAILED DESCRIPTION

Various embodiments will be described hereinafter with reference to the accompanying drawings.

In general, according to one embodiment, a camera comprises: a case provided with an opening portion; and a front unit fixed to the case to cover the opening portion. The front unit comprises: a sensor holder comprising a sensor support unit which is housed in the case and to which an image sensor is fixed, and a fitting portion protruding from the sensor support unit to the outside of the case; a front cover provided with a fitting hole in which the fitting portion is fitted and covering the opening portion; and a fixing unit which detachably fixes the front cover to the sensor holder.

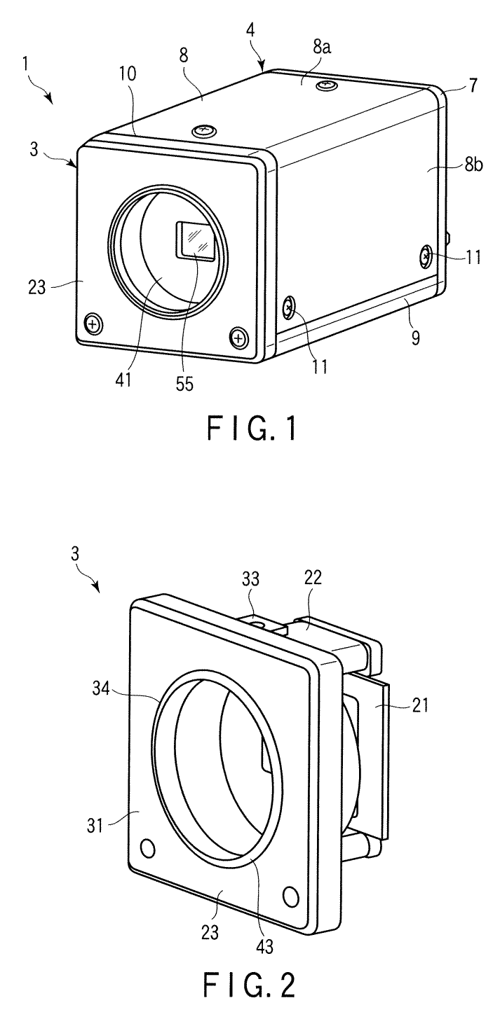

Referring to FIGS. 1-10, a first embodiment will be described.

FIG. 1 is a perspective view showing a camera 1 according to a first embodiment.

In FIG. 1, the camera 1 comprises a front unit 3 and a case 4.

The case 4 comprises a rear cover 7, an upper cover 8, and a bottom cover 9. The case 4 takes the shape of a square tube. The upper cover 8 is formed in a U-shape by press-forming a plate. The upper cover 8 comprises a top wall 8a and a pair of side walls 8b, 8c. Side wall 8c is shown in FIG. 8.

The bottom cover 9 is fixed to the side walls 8b, 8c of the upper cover 8 by screws 11. The rear cover 7 covers a rear end of the upper cover 8. An opening portion 10 is provided at a front end of the case 4, and is located opposite to the rear cover 7.

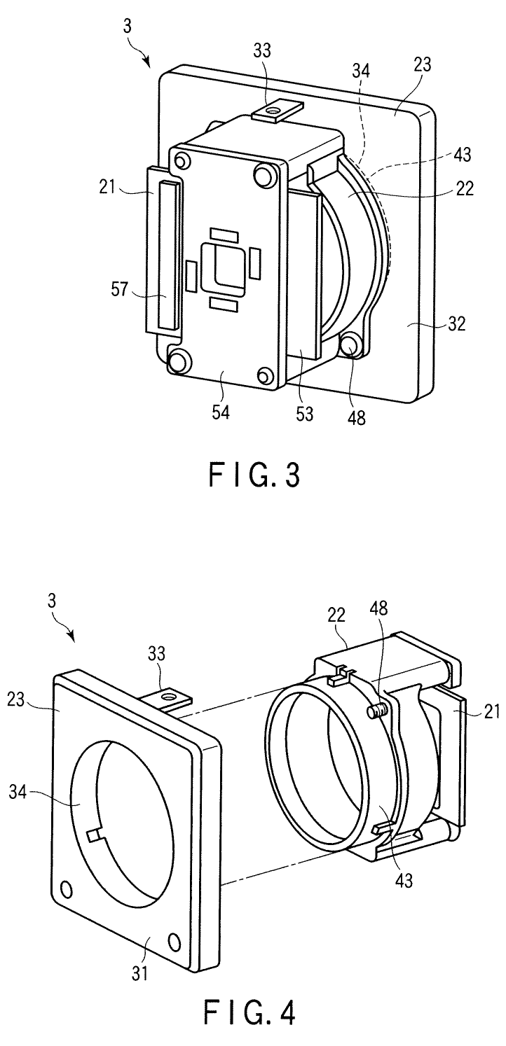

Next, referring to FIGS. 2-4, the front unit 3 will be described. FIG. 2 is a perspective view showing the front unit 3. FIG. 3 is a perspective view of the front unit 3 viewed from back. FIG. 4 is an exploded perspective view of the front unit 3.

The front unit 3 comprises a sensor unit 21, a sensor holder 22 and a front cover 23. As shown in FIG. 1, the front unit 3 is located in the case 4 in such a manner that the front cover 23 covers the opening portion 10.

The sensor holder 22 and front cover 23 are each made of a metallic material such as an aluminum alloy. The sensor holder 22 and front cover 23 have a sufficient hardness and thermal conductivity. The sensor holder 22 and front cover 23 are not necessarily made of the above material, but may be made of another material. Further, the sensor holder 22 may be made of a different material from the front cover 23.

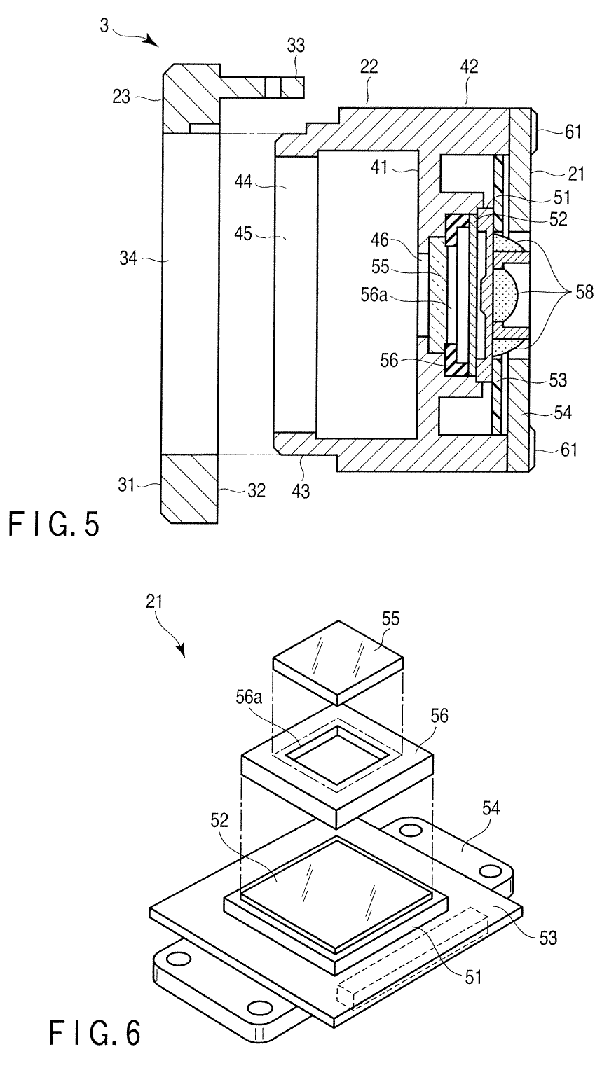

FIG. 5 is a longitudinal sectional view of the front unit 3 of FIG. 4. Referring to FIG. 5, the configuration of the front unit 3 will be described in detail.

The front cover 23 of the front unit 3 takes the form of a rectangular plate as shown in FIG. 4. The front cover 23 comprises a first surface 31 and a second surface 32. The first surface 31 is exposed to the outside of the case 4. The second surface 32 is located opposite to the first surface 31, and faces inward of the case 4.

The second surface 32 of the front cover 23 is provided with a screw receiving portion 33 protruding inward of the case 4. The screw receiving portion 33 is placed on the upper wall 8a of the upper cover 8 from inside of the case 4.

A circular fitting hole 34 is formed in the front cover 23. The fitting hole 34 extends from the first surface 31 through the front cover 23 to the second surface 32.

The sensor holder 22 comprises a sensor support unit 42 including an inner wall 41, a fitting portion 43, and a lens mount 44. The sensor support unit 42 is housed in the case 4.

The fitting portion 43 takes the form of a cylinder having a size that allows the fitting portion 43 to be fitted in the fitting hole 34. The fitting portion 43 protrudes from the inner wall 41 to the outside of the case 4. The lens mount 44 is provided in the fitting portion 43. A columnar lens 45 is mounted on the lens mount 44.

The inner wall 41 is provided with a rectangular light receiving hole 46. The sensor unit 21 is attached to the sensor support unit 42 from a side opposite to the lens mount 44 in such a manner that the sensor unit 21 is supported by the inner wall 41.

As shown in FIGS. 2 and 4, the fitting portion 43 of the sensor holder 22 is fitted in the fitting hole 34 from a side of the second surface 32 of the front cover 23. In this state, the sensor holder 22 is detachably fixed to the front cover 23 from inside the case 4 by means of a screw 48 as shown in FIG. 3. The screw 48 is an example of a fixing unit.

FIG. 6 is an exploded perspective view of the sensor unit 21.

The sensor unit 21 comprises an image sensor 51, a glass plate 52, a circuit board 53, a frame 54, a filter glass 55, a filter packing 56, and a connector 57. The connector 57 is shown in FIG. 3.

The image sensor 51 is, for example, a CMOS image sensor formed of a rectangular semiconductor package. The image sensor 51 involves heat emission during operation. The glass plate 52 covers a light receiving surface of the image sensor 51.

The circuit board 53 has a rectangular shape having a size allowing the circuit board 53 to be contained in the sensor support unit 42. As shown in FIG. 5, the circuit board 53 is fixed to the frame 54 by an adhesive 58. The image sensor 51 and connector 57 are fixed to the circuit board 53 by, for example, soldering.

The filter packing 56 is placed on the glass plate 52 covering the image sensor 51. A light passage hole 56a is provided in the filter packing 56. The filter glass 55 is placed on the filter packing 56 in such a manner as to cover the light passage hole 56a.

As shown in FIG. 5, the frame 54, to which the circuit board 53 is fixed, to the sensor support unit 42 by a plurality of screws 61. When the frame 54 is fixed to the sensor support unit 42, the filter glass 55 covers the light receiving hole 46 from the side opposite to the lens mount 44. The filter glass 55, light passage hole 56a, glass plate 52, image sensor 51, and light receiving hole 46 of the sensor holder 22 are arranged on the same axis.

As mentioned above, the sensor unit 21 is fixed to the sensor holder 22. With this configuration, the image sensor 51 is fixed to the sensor support unit 42 via the circuit board 53 and frame 54.

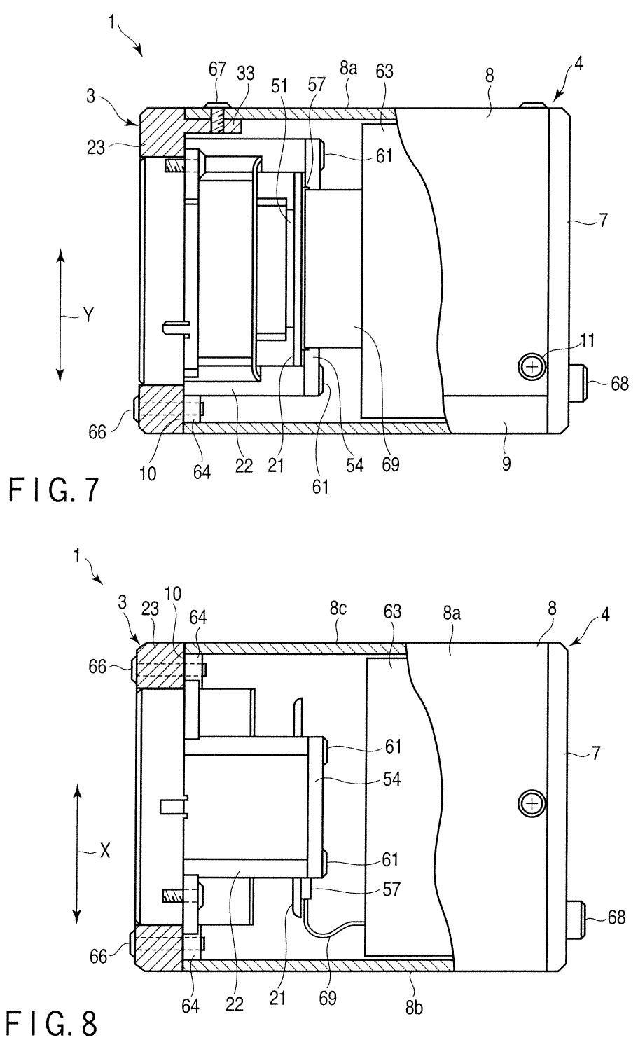

Next, referring to FIGS. 7 and 8, the internal configuration of the camera 1 will be described. FIG. 7 is a side view in which part of the case 4 is cut out to show the internal configuration of the camera 1. FIG. 8 is a top view in which part of the case 4 is cut out.

Hereinafter, the direction indicated by arrow Y in FIG. 7, which is orthogonal to the top wall 8a, will be referred to as the “vertical direction”, and the direction indicated by arrow X in FIG. 8, which is orthogonal to the side wall 8b, 8c, will be referred to as the “lateral direction.”

As shown in FIG. 7, the bottom cover 9 comprises a screw receiving portion 64. The screw receiving portion 64 is adjacent to the opening portion 10 and protrudes inward of the case 4. The front cover 23 is placed on the screw receiving portion 64 of the bottom cover 9 in such a manner as to cover the opening portion 10. The front cover 23 is fixed to the bottom cover 9 by screwing a front side screw 66 in the screw receiving portion 64 from outside of the camera 1.

The screw receiving portion 33 of the front cover 23 is placed on the top wall 8a of the upper cover 8 from inside of the case 4. The front cover 23 is fixed to the top wall 8a by screwing an upper side screw 67 in the screw receiving portion 33 from outside of the case 4. The front unit 3 is thereby fixed to the case 4.

An image processing unit 63 is contained in the case 4 and interposed between the front unit 3 and the rear cover 7. The image processing unit 63 comprises an output terminal 68. The output terminal 68 is, for example, a BNC connector. The output terminal 68 protrudes through the rear cover 7 to the outside of the case 4. The image processing unit 63 is connected to the sensor unit 21 via a flat cable 69.

The flat cable 69 is a belt-shaped cable comprising a plurality of cables. One end of the flat cable 69 is connected to the image processing unit 63. The other end of the flat cable 69 is connected to the connector 57 of the sensor unit 21.

The image processing unit 63 coverts image data received from the image sensor 51 into a signal according to an output method. For example, the image processing unit 63 converts image data into a signal in an interlace system. The image processing unit 63 outputs the converted signal from the output terminal 68.

The output terminal 68 is not limited to the BNC connector, and may be a terminal of a different standard, such as a DVI connector. Further, the image processing unit 63 may convert image data into not only the signal in the interlace system, but also a signal in a progressive system.

The image processing unit 63 involves heat emission during operation. The amount of heat emitted by the image processing unit 63 depends on the type of signal to be converted, the resolution of the image data, and the frame rate. Generally, as the amount of data processed per unit of time increases, the amount of heat emitted by the image processing unit 63 increases.

For example, the progressive system is an output method for dealing with image data of a higher resolution than the interlace system, and the amount of data to be processed is large. Therefore, when the image processing unit 63 converts image data into a signal in the progressive system, the amount of heat emitted by the image processing unit 63 increases.

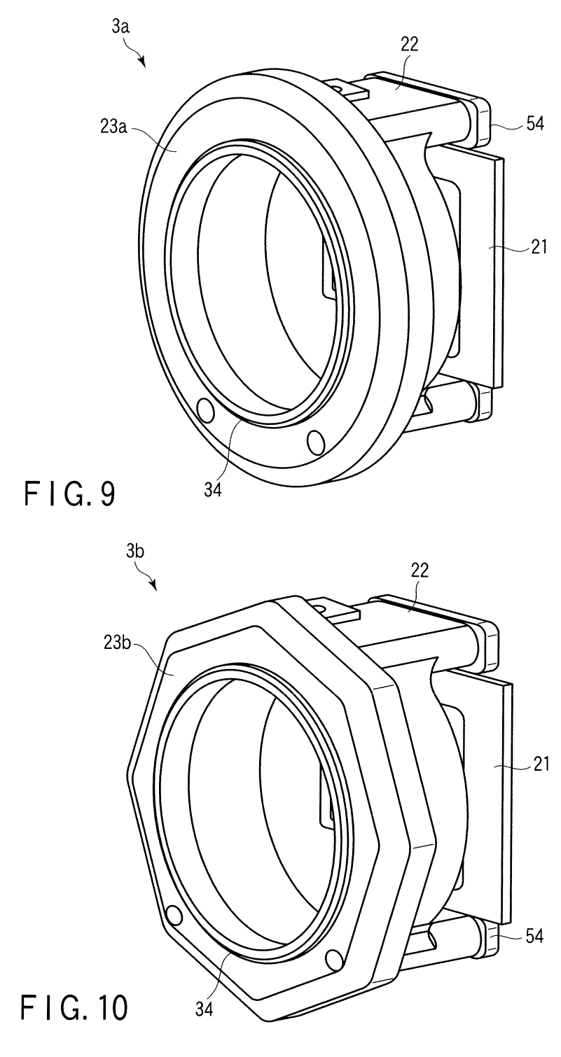

The configuration of the camera 1 has been described so far. The shape of the front cover 23 is not limited to the rectangular plate as shown in FIGS. 1-8, and may be another shape. Referring to FIGS. 9 and 10, another form of the front cover 23 will be described.

FIG. 9 is a perspective view showing another form of the front unit 3. A front unit 3a shown in FIG. 9 comprises a ring-shaped front cover 23a. The front unit 3a shown in FIG. 9 is different from the front unit 3 shown in FIGS. 1-8 only in terms of the shape of the front cover 23a.

The front cover 23a is attached to the sensor holder 22 instead of the front cover 23 shown in FIGS. 1-8. The fitting hole 34 and screw hole, in which the screw 48 is inserted, of front cover 23a are located at the same positions as the fitting hole 34 and screw hole of front cover 23.

FIG. 10 is a perspective view showing another form of the front unit 3. A front unit 3b shown in FIG. 10 comprises a front cover 23b taking a form of a polygonal plate. The front unit 3b shown in FIG. 10 is different from the front unit 3 shown in FIGS. 1-8 only in terms of the shape of the front cover 23b.

The front cover 23b is attached to the sensor holder 22 instead of the front cover 23 shown in FIGS. 1-8. The fitting hole 34 and screw hole, in which the screw 48 is inserted, of front cover 23b are located at the same positions as the fitting hole 34 and screw hole of front cover 23.

If the camera 1 has the above-described configuration, even when multiple types of front units 3 having different appearances are made, only the front cover 23 needs to be newly designed and manufactured.

For example, when the front unit 3a shown in FIG. 9, which is different from the front unit 3 shown in FIGS. 1-8, is made, only the front cover 23a needs to be newly designed and manufactured. When the front unit 3b shown in FIG. 10, which is different from the front unit 3 shown in FIGS. 1-8, is made, only the front cover 23b needs to be newly designed and manufactured.

In other words, the cameras 1 having the above-described configuration can employ a common sensor holder 22, regardless of the shape of the front cover 23 if the shapes of the sensor unit 21 and image sensor 51 are common.

In addition, the front unit 3 comprises the sensor holder 22 and the front cover 23 as separate parts. Therefore, the need for a rib for connecting the sensor holder 22 to the front cover 23 at the time of casting is eliminated.

Accordingly, even when a plurality of cameras 1 having different appearances are manufactured, the work hours and costs associated with designing the sensor holder 22 may be omitted. Moreover, the costs associated with molds and manufacturing costs per unit related to the front unit 3 can be reduced. Therefore, the design and manufacturing costs involved in new development of the camera 1 can be lowered.

Further, when a new camera 1 with a front cover having a different shape is manufactured in accordance with the intended purpose, the front unit 3 can be made merely by newly designing the front cover 23. Therefore, flexibility in designing of the appearance of the camera 1 is increased.

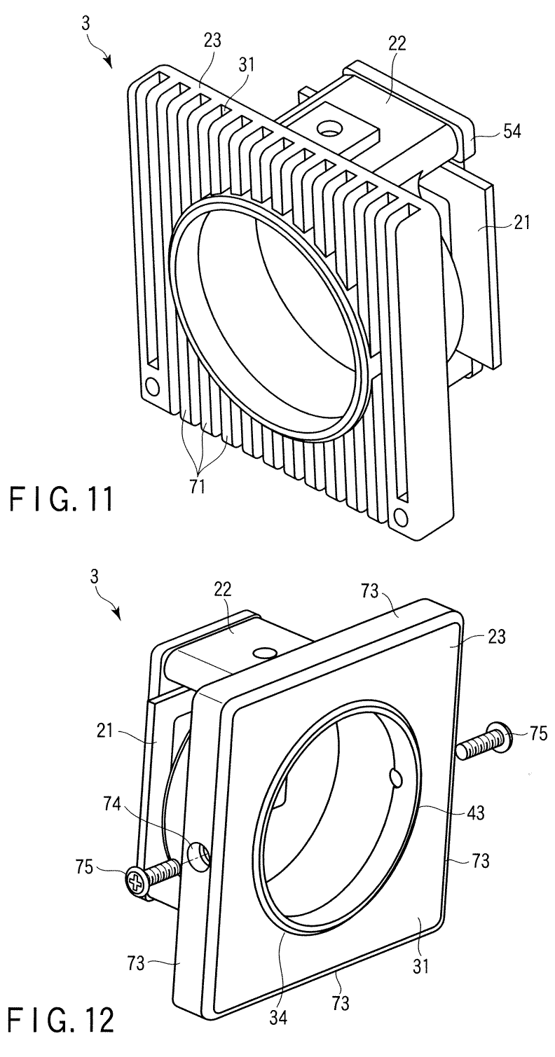

Next, referring to FIG. 11, a second embodiment will be described. In the second embodiment, the configurations having the same functions as the configurations of the camera 1 of the first embodiment will be assigned the same reference symbols, and the explanations thereof will be omitted.

FIG. 11 is a perspective view showing the front unit 3 according to the second embodiment. The front cover 23 of the front unit 3 comprises a plurality of radiating fins 71. The radiating fins 71 are provided on the first surface 31. The radiating fins 71 are formed integrally with the front cover 23. The radiating fins 71 efficiently release heat generated by the image sensor 51 and image processing unit 63 to the outside of the case 4.

If the camera 1 has the above-described configuration, the radiation performance of the camera 1 can be easily changed. More specifically, the front cover 23 comprising the radiating fins 71 is removable from the sensor holder 22. Therefore, the front cover 23 can be easily replaced with another front cover 23 comprising radiating fins 71 having a different radiation performance.

For example, when a large amount of heat is generated by the image processing unit 63 or when the camera 1 is used under a high temperature condition, the front cover 23 is replaced with a front cover 23 comprising radiating fins 71 having a high radiation performance. In this way, the cooling performance according to the usage environment or need can be easily attained.

In addition, when the radiation performance of a new camera 1 is tested, data of a plurality of conditions can be easily obtained. More specifically, if a camera 1 and a plurality of front covers 23 having different sets of radiating fins 71 are prepared, data on radiation performance of multiple types of cameras 1 can be obtained by changing the front covers 23.

Accordingly, the radiation performance of the camera 1 can be easily examined. This configuration achieves not only easier examination of the radiation performance, but also easier examination of other conditions, such as durability.

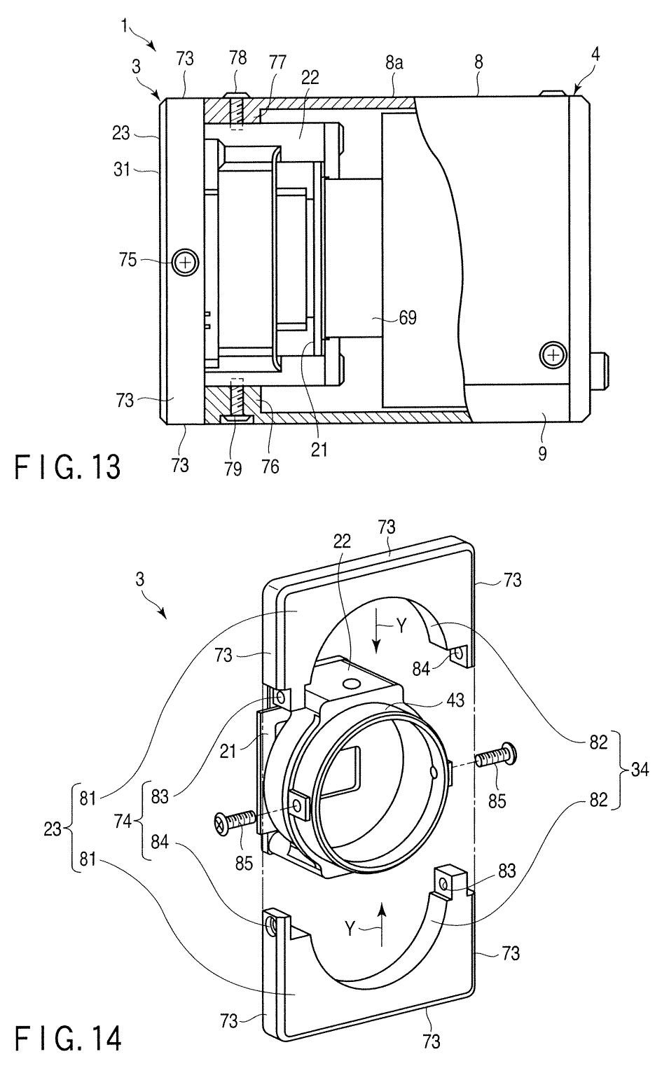

Next, referring to FIGS. 12 and 13, a third embodiment will be described. In the third embodiment, the configurations having the same functions as the configurations of the camera 1 of the first embodiment will be assigned the same reference symbols, and the explanations thereof will be omitted.

FIG. 12 is a perspective view showing the front unit 3 according to the third embodiment. The front cover 23 of the front unit 3 comprises four side surfaces 73 instead of the screw receiving portion 33 of the first embodiment. The four side surfaces 73 are each exposed to the outside of the case 4.

A pair of fixing holes 74 are respectively provided in two side surfaces 73 opposed to each other. The fixing holes 74 each extend from the side surfaces 73 to the fitting hole 34. A screw 75 is inserted from each of the fixing holes 74 from outside of the camera 1.

The screw 75 is screwed in the sensor holder 22 through the fixing hole 74, and detachably fixes the front cover 23 to the sensor holder 22. The screw 75 is an example of the fixing unit.

The fixing hole 74 is not necessarily provided in the side surfaces 73, and may be provided in a portion exposed to the outside of the case 4, such as the first surface 31.

FIG. 13 is a side view showing the camera 1 according to the third embodiment. In FIG. 13, part of the case 4 is cut out to show the internal configuration of the camera 1.

The bottom cover 9 comprises a lower thick portion 76 instead of the screw receiving portion 64 of the first embodiment. The lower thick portion 76 protrudes inward of the case 4. The upper cover 8 comprises an upper thick portion 77. The upper thick portion 77 protrudes inward of the case 4 from the top wall 8a. The lower thick portion 76 and upper thick portion 77 hold the sensor holder 22 therebetween.

The sensor holder 22 is fixed to the top wall 8a of the upper cover 8 by an upper screw 78. The upper screw 78 is screwed from outside of the case 4 through the upper thick portion 77 in the sensor holder 22.

The sensor holder 22 is also fixed to the bottom cover 9 by a lower screw 79. The lower screw 79 is screwed from outside of the case 4 through the lower thick portion 76 in the sensor holder 22. The front unit 3 is thereby fixed to the case 4.

If the camera 1 has the above-described configuration, the sensor holder 22 is detachably fixed to the front cover 23 by screwing the screw 75 in from outside of the camera 1. This configuration makes it possible to replace the front cover 23 with the sensor holder 22 fixed to the case 4 when only the front cover 23 is changed after the camera 1 is assembled.

Next, referring to FIG. 14, a fourth embodiment will be described. In the fourth embodiment, the configurations having the same functions as the configurations of the camera 1 of the third embodiment will be assigned the same reference symbols, and the explanations thereof will be omitted.

FIG. 14 is an exploded perspective view of the front unit 3 according to the fourth embodiment. The front cover 23 of the front unit 3 is formed of a pair of segments 81. The fourth embodiment is different from the third embodiment in this respect.

The pair of segments 81 have the same shape. The pair of segments 81 are combined to form the front cover 23. The segments 81 each comprise a concave portion 82. A first hole 83 and a second hole 84 are formed in each of the segments 81.

The first and second holes 83, 84 are provided at both ends of each of the segments 81 with the concave portion 82 interposed therebetween. When the pair of segments 81 are combined, the concave portion 82 defines the fitting hole 34 and the first hole 83 and second hole 84 define the fixing hole 74.

The pair of segments 81 hold the fitting portion 43 therebetween in a vertical direction indicated by arrow Y in FIG. 14, and combined with each other to form the front cover 23. When the front cover 23 is formed, the fitting portion 43 is fitted in the fitting hole 34 defined by the pair of concave portions 82.

A screw 85 is screwed from each of the fixing holes 74 in the sensor holder 22, thereby detachably fixing the sensor holder 22 to the front cover 23. The screw 85 is an example of the fixing unit. The front unit 3 is formed accordingly.

The front unit 3 need not necessarily be formed in the above-described manner, and may be formed in another manner. For example, the front unit 3 may be formed by fitting the fitting portion 43 in the fitting hole 34 in a state where the pair of segments 81 are combined and the front cover 23 is formed.

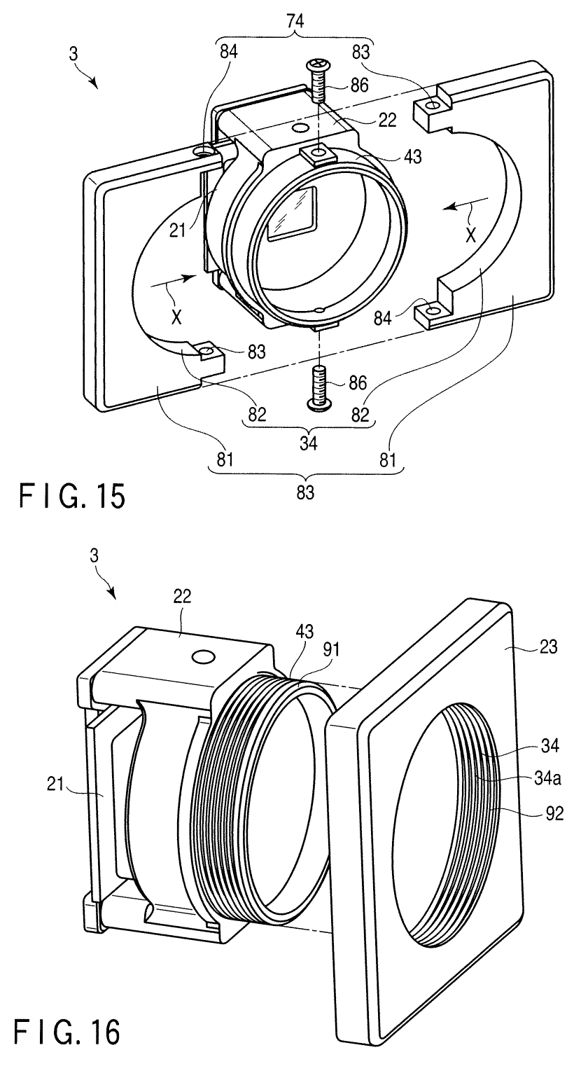

Next, referring to FIG. 15, a fifth embodiment will be described. In the fifth embodiment, the configurations having the same functions as the configurations of the camera 1 of the fourth embodiment will be assigned the same reference symbols, and the explanations thereof will be omitted.

FIG. 15 is an exploded perspective view showing the front unit 3 according to the fifth embodiment. The pair of segments 81 hold the fitting portion 43 therebetween in a lateral direction indicated by arrow X in FIG. 15. The fifth embodiment is different from the fourth embodiment in this respect.

The front cover 23 is formed of the pair of segments 81. The pair of segments 81 hold the fitting portion 43 therebetween in the lateral direction. A screw 86 is screwed in the sensor holder 22 from each of the fixing holes 74 defined by the first and second holes 83, 84. The screw 86 detachably fixes the sensor holder 22 to the front cover 23. The screw 86 is an example of a fixing unit. The front unit 3 is formed accordingly.

Next, referring to FIG. 16, a sixth embodiment will be described. In the sixth embodiment, the configurations having the same functions as the configurations of the camera 1 of the third embodiment will be assigned the same reference symbols, and the explanations thereof will be omitted.

FIG. 16 is a perspective view showing a state where the sensor holder 22 and front cover 23 of the front unit 3 are separated according to the sixth embodiment. A male screw portion 91 is provided to the fitting portion 43 of the sensor holder 22. A female screw portion 92 is provided at an edge portion 34a of the front cover 23, which defines the fitting hole 34.

The male screw portion 91 of the fitting portion 43 is screwed in the female screw portion 92 of the fitting hole 34. The front cover 23 is thereby detachably fixed to the sensor holder 22.

If the camera 1 has the above-described configuration, the area where the sensor holder 22 comes into contact with the front cover 23 is large since the male screw portion 91 is screwed in the female screw portion 92. Therefore, a good thermal conductivity between the sensor holder 22 and the front cover 23 is realized.

In addition, the screw to fix the front cover 23 to the sensor holder 22 can be omitted. Thus, the number of parts and the manufacturing costs of the camera 1 per unit can be reduced.

The present invention is not limited to the above-described embodiments, and may be variously changed and modified within the scope of the spirit of the invention in the stage of implementation. The embodiments may be implemented in any possible combination.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera comprising;
a case provided with an opening portion; and
a front unit fixed to the case to cover the opening portion,
wherein the front unit comprises:
a sensor holder comprising a sensor support unit which is housed in the case and to which an image sensor is fixed, and a fitting portion protruding from the sensor support unit to the outside of the case;
a front cover provided with a fitting hole in which the fitting portion is fitted and covering the opening portion; and
a fixing unit which detachably fixes the front cover to the sensor holder.

2. The camera of claim 1, wherein the front cover comprises a heat radiation fin on a surface exposed to the outside of the case.

3. The camera of claim 1, wherein the fixing unit detachably fixes the front cover to the sensor holder from inside of the case.

4. The camera of claim 1, wherein the fixing unit detachably fixes the front cover to the sensor holder from outside of the case.

5. The camera of claim 1, wherein
the front cover is formed of a plurality of segments combined with each other, and
the segments each have a concave portion which defines the fitting hole when the segments are combined.

6. The camera of claim 5, wherein the segments form the front cover by being vertically combined with the fitting portion interposed therebetween.

7. The camera of claim 5, wherein the segments form the front cover by being laterally combined with the fitting portion interposed therebetween.

8. The camera of claim 1, wherein
the fixing unit comprises a female screw portion provided to an edge portion of the front cover defining the fitting hole, and a male screw portion provided to the fitting portion, and
the front cover is detachably fixed to the sensor holder by screwing the male screw portion in the female screw portion.
